(19) United States
(12) Patent Application Publication
(10) Pub. No.: US 2023/0085213 A1
(43) Pub. Date: Mar. 16, 2023

(54) NEAR INFRARED INDEXER FOR RECYCLING PLASTIC OBJECTS

(71) Applicant: Jeevan SALDANHA, Mangalore (IN)

(72) Inventor: Jeevan SALDANHA, Mangalore (IN)

(21) Appl. No.: 17/911,179

(22) PCT Filed: Mar. 12, 2021
(86) PCT No.: PCT/IN2021/050249

§ 371 Date: Sep. 13, 2022

(30) Foreign Application Priority Data
Mar. 13, 2020 (IN) 202041010786

(51) Int. Cl. G01N 21/3563; G01N 21/90

(52) U.S. Cl. CPC G01N 21/3563; G01N 21/9081

(57) ABSTRACT

The invention provides a method and a near infrared indexer for recycling plastic objects. The method includes illuminating the plastic objects with a light source for detecting the presence, obtaining spectra in the near infrared region in respect of each of the plastic objects detected, comparing the obtained spectra with a database having spectra of known plastic types and sorting the plastic objects based on the comparison obtained. The accuracy of sorting of the plastic objects is above 95%. The method utilizes near infrared range of 600 nm-1000 nm. The indexer includes a first optical chamber. A second optical chamber is coupled to the first optical chamber. A sorting arrangement having an exit chamber is positioned proximal to the second optical chamber. The exit chamber is provided with a first collection chute and a second collection chute.

### FIELD OF INVENTION

The invention generally relates to the field of mechanical engineering. More specifically, this invention relates to a method and apparatus for sorting of plastic objects.

### BACKGROUND

Plastic is a major product used everywhere in day to day life. It is durable, corrosion resistant, chemically inert, light weight, strong and resilient. Due to cost effectiveness and high efficiency of the plastic materials, demand in manufacturing of consumer plastic has increased. The growth in the manufacturing of the consumer plastics is alarming and it causes severe environmental issues in terms of disposal, land filling and pollution when the materials are burnt. Therefore, recycling of the plastic products is a very important in order to protect the environment. For the effective recycling, it is necessary that these consumer plastic materials are identified, classified and separated. Normally, different methods like density, electrical, magnetic or chemical separation are used to sort the consumer waste plastics. The disadvantage associated with these methods is, they are not applicable to similar polymers, like co-polymers or polymer blends as well as material with different additives.

To overcome these evident disadvantages, there are machines available in the prior arts. In one of the prior arts, a dual infrared on-line plastic material sorting device is provided. It includes a broadband infrared light source, a conveyor belt, a light gathering device, a background device, a light splitting device, two infrared bandpass filters, two camera lenses, two infrared linear array sensors and a control system. The broadband infrared light source irradiates a plastic surface that is conveyed to the background device through the conveyor belt. The light reflected from the plastic surface is divided into two paths equally. The two paths of light are passed through the infrared band pass filters, which are then received by respective camera lenses, and images are formed on the infrared linear array sensors. The control system reads the images and distinguishes the PET and PVC plastics. One of the infrared band pass filters has a wavelength observation range of 1150-1230 nm, and the other infrared band pass filter has a wavelength observation range of 1600-1700 nm. The device as mentioned hereinabove has disadvantages in terms of time consumption, complex method and structures, cost and accuracy in the sorting process. In another prior art, a plastic waste sorting system for five types of plastics, is provided. The system uses near infrared light to indentify the different polymers. In the system, the plastic wastes are subjected to irradiation with the near infrared light for obtaining reflectance NIR spectroscopy. The obtained NIR spectroscopy in the spectral range of 1100-1750 nm, is analyzed to identify and sort the five types of plastics. However, the system is not suitable for sorting dark colored plastic objects and is highly expensive.

Therefore, there is a need for a machine for sorting consumer waste plastics that is efficient in terms of cost, accuracy and time.

### BRIEF DESCRIPTION OF DRAWINGS

So that the manner in which the recited features of the invention can be understood in detail, some of the embodiments are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a near infrared indexer for recycling plastic objects, according to an embodiment of the invention.

FIG. 2 shows the initial feeding section of the near infrared indexer, according to an embodiment of the invention.

FIG. 3 shows the optical sorting section of the near infrared indexer, according to an embodiment of the invention.

### SUMMARY OF THE INVENTION

One aspect of the invention provides a method for sorting of plastic objects. The method includes illuminating the plastic objects with a light source for detecting the presence, obtaining spectra in the near infrared region in respect of each of the plastic objects detected, comparing the obtained spectra with a database having spectra of known plastic types and sorting the plastic objects based on the comparison obtained. The accuracy of sorting of the plastic objects is above 95%. The method utilizes near infrared range of 600 nm-1000 nm.

Another aspect of the invention provides a near infrared indexer for recycling plastic objects. The indexer includes a first optical chamber. A second optical chamber is coupled to the first optical chamber. A sorting arrangement having an exit chamber is positioned proximal to the second optical chamber. The exit chamber is provided with a first collection chute and a second collection chute.

### DETAILED DESCRIPTION OF THE INVENTION

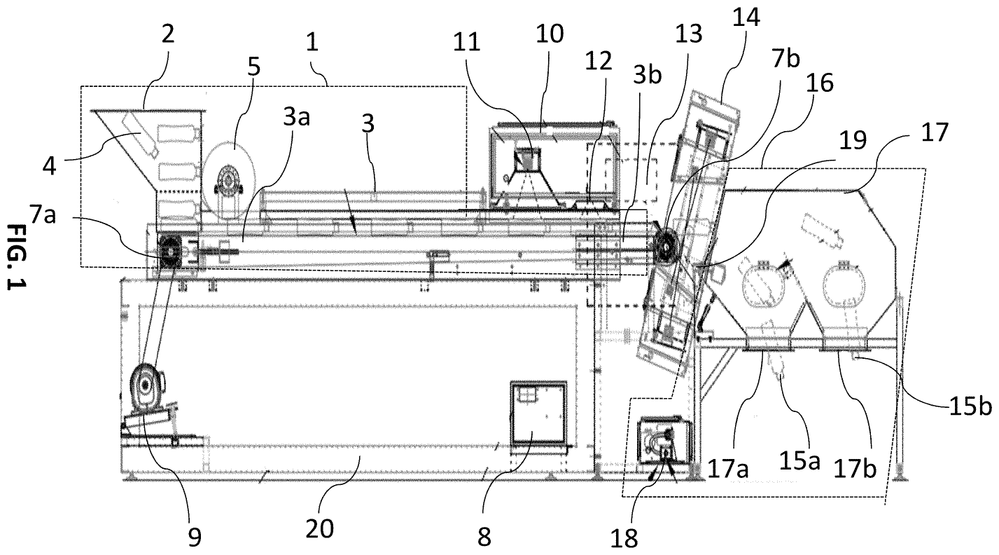

Various embodiments of the invention provide a method and a near infrared indexer for recycling plastic objects. The method includes illuminating the plastic objects with a light source for detecting the presence, obtaining spectra in the near infrared region in respect of each of the plastic objects detected, comparing the obtained spectra with a database having spectra of known plastic types and sorting the plastic objects based on the comparison obtained. The method described hereinabove shall be explained in detail through FIG. 1-FIG. 3.

FIG. 1 shows a near infrared recycling indexer, according to an embodiment of the invention. The indexer includes a feeding means 1 for feeding the plastic objects. The feeding means includes but is not limited to an in-feed hopper, a vibratory feeder and a horizontal belt conveyor. In one embodiment of the invention, the plastic objects 4 are fed into the in-feed hopper 2. The constituent of the plastic objects 4 described herein include but are not limited to polyethylene terephthalate (PET), high density polyethylene (HDPE) and low density polyethylene (LDPE), polyvinyl Chloride (PVC), polypropylene (PP) and polystyrene (PS) materials. The plastic materials 4, subsequent to being fed through the in-feed hopper 2, are passed through the horizontal belt conveyor 3 with the help of a brush or pinch feed roller 5. The horizontal belt conveyor 3 includes a first end 3a and a second end 3b. Each of the first end 3a and second end 3b are provided with a first driving drum 7a and a second driving drum 7b respectively. The indexer further includes a sub control panel 8. The sub control panel 8 is configured to control the speed of rotation of the first driving drum 7a and the second driving drum 7b through a geared motor 9. The geared motor 9 is coupled to the first driving drum 7a and the second driving drum 7b. In one example of the invention, the geared motor 9 is coupled to the driving drums through belt pulleys. The sub control panel 8 includes an ac drive unit. A first optical chamber 10 is coupled to the feeding means 1. The plastic objects 4 running through the horizontal belt conveyor 3 are then allowed to enter into the first optical chamber 10. The first optical chamber 10 includes a camera 11 and a spectrometer 12 for obtaining the visible and near infrared spectra of the plastic objects, in order to sort the plastic objects into different categories. In one embodiment of the invention, the camera 11 is replaced with another spectrometer operating in the visible range. The plastic objects 4 are subjected to illumination with the visible and/or near infrared light, subsequent to which, two spectra, one in the range of 600 nm-1000 nm of near infrared and another in the range of 400 nm-600 nm of visible are obtained. A main control panel 13 is coupled to the indexer. The main control panel 13 includes electronic boards, circuits and user interface. The main control panel 13 compares the obtained spectra with a database having spectra of known plastic types. The main control panel 13 activates an air-jet (not shown) for sorting the plastic objects based on the comparison obtained. The sorting can be based on opacity, transparency, colour and constituent material of the plastic objects. In one embodiment of the invention, the plastic materials are sorted based on different constituent materials. The constituent materials of the plastic objects include but are not limited to polyethylene terephthalate (PET), high density polyethylene (HDPE), low density polyethylene (LDPE), polyvinyl Chloride (PVC), polypropylene (PP) and polystyrene (PS) materials. In one embodiment of the invention, the plastic objects are allowed to enter into a second optical chamber 14 for optically scanning the plastic objects. The second optical chamber 14 is coupled to the first optical chamber 10. The second optical chamber 14 is provided with an optical arrangement to detect the coloured plastics 15a and transparent plastics 15b. A sorting arrangement 16 having an exit chamber 17 is positioned proximal to the second optical chamber 14 for sorting the coloured plastics 15a and the transparent plastics 15b. The exit chamber 17 is provided with a first collection chute 17a and a second collection chute 17b. The sorting arrangement 16 further includes ejector valves (not shown) housed in the ejector chamber 18 and an ejector nozzle arrangement 19. The ejector nozzle arrangement 19 is connected to the ejector valves. The ejector nozzle arrangement 19 contains the compressed air. When the transparent plastics 15b come closer to the ejector nozzle arrangement 19, the main control panel 13 instructs the ejector chamber 18 to open the ejector nozzle arrangement 19. The compressed air contained in the ejector nozzle arrangement 19 is blown out and as a result, the transparent plastics 15b are separated from the coloured plastics 15a. The coloured plastics 15a, subsequent to sorting, are allowed to fall through the first collection chute 17a and the transparent plastics 15b are allowed to fall through the second collection chute 17b. The indexer is mounted on a body frame 20. In one embodiment of the invention, sorting of PET and non PET plastics are also achieved using the indexer.

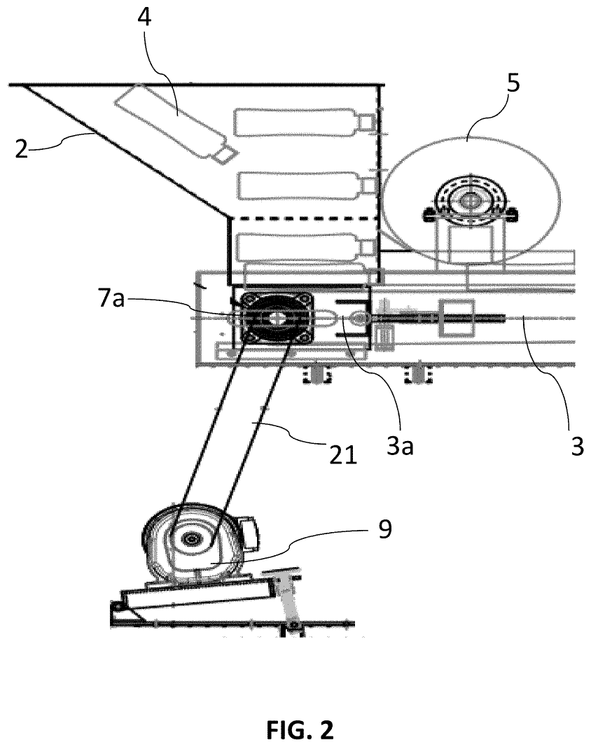

FIG. 2 shows the initial feeding section of the automated maturity indexer, according to an embodiment of the invention. Initially, the plastic objects 4 are fed into a feeding means 1. The feeding means 1 includes an in-feed hopper or a vibratory feeder and a horizontal belt conveyor 3. In one embodiment of the invention, the plastic objects 4 are fed into the in-feed hopper 2. The constituent material of plastic objects 4 contained in the in-feed hopper 2 include but are not limited to polyethylene terephthalate (PET), high density polyethylene (HDPE), low density polyethylene (LDPE), polyvinyl Chloride (PVC), polypropylene (PP) and polystyrene (PS) materials.

The plastic objects 4, subsequent to being fed through the in-feed hopper 2, are passed through a horizontal belt conveyor 3 with the help of a brush or pinch feed roller 5. A first end 3a of the horizontal belt conveyor 3 includes a driving drum 7a. The speed of rotation of the driving drum 7a is controlled by a sub control panel 8 through a geared motor 9. The geared motor 9 drives a belt 21 through belt pulleys.

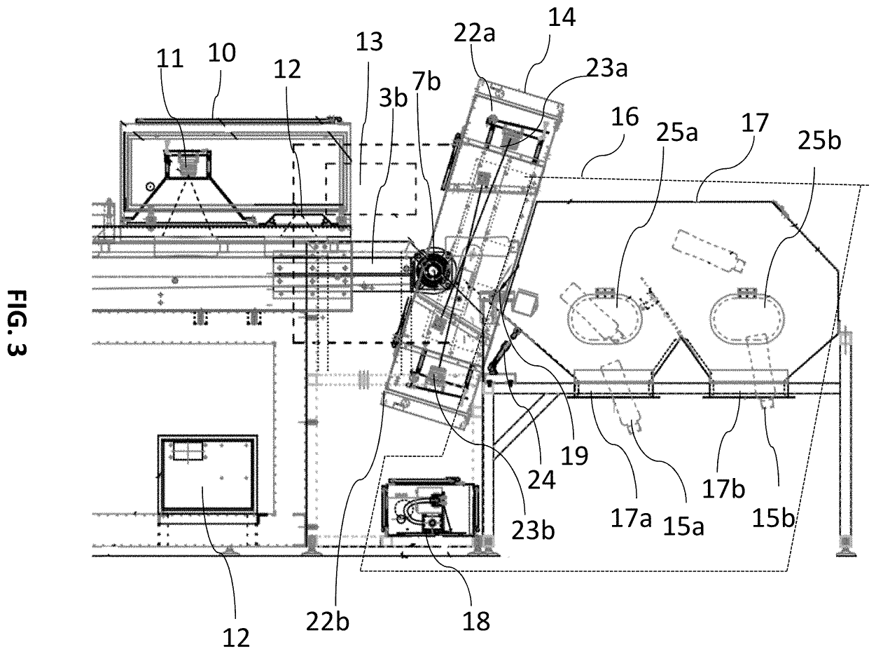

FIG. 3 shows the optical sorting section of the near infrared recycling indexer, according to an embodiment of the invention. The indexer includes a first optical chamber 10. The first optical chamber 10 includes a camera 11 and a spectrometer 12. In the first optical chamber, the plastic objects are illuminated with visible and near Infra-red light in the range of 600 nm to 1000 nm and respective visible and NIR spectra are obtained through the camera/visible spectrometer 10 and spectrometer 12. A main control panel 13 is coupled to the indexer. The main control panel 13 includes electronic boards, circuits and user interface. The main control panel 13 compares the obtained spectra with a database having spectra of known plastic types. The control panel activates an air-jet for sorting the plastic objects based on the comparison obtained. The sorting can be based on opacity, transparency, colour and constituent material of the plastic objects. In one embodiment of the invention, the plastic materials are sorted based on different constituent materials. The constituent materials of the plastic objects include but are not limited to polyethylene terephthalate (PET), high density polyethylene (HDPE), low density polyethylene (LDPE), polyvinyl Chloride (PVC), polypropylene (PP) and polystyrene (PS) materials. In one example of the invention, the reference spectra is in the form of a lookup table that is generated using one of the multivariate processes called Partial Least Square Method.

A second optical chamber 14 is coupled to the first optical chamber 10. In one embodiment of the invention, the plastic objects are allowed to pass into the second optical chamber 14. The second optical chamber 14 includes a first end 22a and a second end 22b. Each of the first end 22a and second end 22b are provided with a first camera 23a and a second camera 23b, respectively. The cameras 23a and 23b are configured to capture a high resolution image of the plastic objects for detection of coloured plastics 15a and transparent plastics 15b through an image processing technique. In another embodiment of the invention, the plastic materials are scanned using the suitable cameras from the top and/or the bottom.

In one example of the invention, the camera can be a single and/or multiple cameras. The camera described herein includes but is not limited to a ccd camera, a monochromatic camera, a trichromatic camera, and/or an infra-red camera. The illumination of the plastic materials is achieved by means of suitable foreground lighting and background lighting. The intensity of foreground lighting is adjustable and can be adjusted from batch to batch in order to optimize the separation in the visible range up to 600 nm. Similarly the intensity of background lighting is adjustable and can be adjusted from batch to batch in order to optimize the separation of the plastic objects. Further, the collected data from the cameras is processed using various algorithms, subsequent to which the coloured plastics 15a and transparent plastics 15b are identified on the basis of colour and/or shape and/or size, and separated from the group of the classified plastic objects as they pass through a sorting arrangement 16. The sorting arrangement 16 having an exit chamber 17 is positioned proximal to the second optical chamber 14 for sorting the coloured plastics 15a and the transparent plastics 15b. The sorting arrangement 16 includes ejector valves (not shown) housed in the ejector chamber 18 and an ejector nozzle arrangement 19. The ejector nozzle arrangement 19 is connected to the ejector valves. The ejector nozzle arrangement 19 contains the compressed air. When the transparent plastics 15b come closer to the ejector nozzle arrangement 19, the main control panel 13 instructs the ejector chamber 16 to open the ejector nozzle arrangement 19. The compressed air contained in the ejector nozzle arrangement 19 is blown out and as a result, the transparent plastics 15b are separated from the coloured plastics 15a. The exit chamber 17 is provided with a first collection chute 17a and a second collection chute 17b. In one embodiment of the invention, the separation is carried out using a deflector 24 instead of ejector valves. The coloured plastics 15a, subsequent to sorting are allowed to fall through the first collection chute 17a and the transparent plastics 15b are allowed to fall through the second collection chute 17b. Each of collection chute 17a and 17b possesses a viewing window 25a and 25b respectively.

### INDUSTRIAL APPLICATION

Initially, plastics objects are fed into a feeding means. The feeding means transfer the plastic objects into a first optical chamber and a second optical chamber for sorting the plastic objects based on opacity, transparency, colour and constituent material of the plastic objects. The first optical chamber includes a camera or a visible spectrometer and an infrared spectrometer. The plastic objects are subjected to irradiation with visible and/or near infrared light, subsequent to which, two spectra, one in the range of 600 nm-1000 nm of near infrared and another in the range of 400 nm-600 nm of visible are obtained. A main control panel compares the obtained spectra with a database having spectra of known plastic types and sorted the plastic objects into different constituent materials by activating an air-jet. The constituent materials of the plastic objects include but are not limited for polyethylene terephthalate (PET), high density polyethylene (HDPE), low density polyethylene (LDPE), polyvinyl Chloride (PVC), polypropylene (PP) and polystyrene (PS) materials. Further, the plastic objects are allowed to enter into the second optical chamber. The second optical chamber includes optical arrangements to detect coloured plastics and transparent plastics. The detected plastic objects are then sorted into coloured and transparent plastics with the help of a sorting arrangement and leaves from an exit chamber.

Hence, the invention provides a method and a near infrared recycling indexer for classification of consumer plastics of interest at a faster rate. The techniques suggested in this invention uses near infrared range of 600 nm to 1000 nm.

The foregoing description of the invention has been set for merely to illustrate the invention and is not intended to be limiting. Since modifications of the disclosed embodiments incorporating the spirit and substance of the invention may occur to person skilled in the art, the invention should be construed to include everything within the scope of the appended claims and equivalents thereof.

I claim:

1. A method for sorting of plastic objects, the method comprising:
illuminating the plastic objects with a light source for detecting the presence;
obtaining spectra in the near infrared region in respect of each of the plastic objects detected;
comparing the obtained spectra with a database having spectra of known plastic types; and
sorting the plastic objects based on the comparison obtained;
wherein the accuracy of sorting of the plastic objects is above 95%.

2. The method as claimed in claim 1, wherein the obtained near infrared spectra is in a range of 600 nm-1000 nm.

3. The method as claimed in claim 1, wherein the sorting can be based on opacity, transparency, colour and constituent material of the plastic objects.

4. The method as claimed in claim 1, wherein the constituent material of the plastic objects include polyethylene terephthalate, high density polyethylene, low density polyethylene, polyvinyl chloride, polypropylene and polystyrene.

5. The method as claimed in claim 1, wherein the light source can be a visible light and/or an infrared light.

6. A near infrared indexer for recycling plastic objects, the indexer comprising:
a first optical chamber;
a second optical chamber coupled to the first optical chamber; and
a sorting arrangement having an exit chamber positioned proximal to the second optical chamber, wherein the exit chamber comprises of a first collection chute for collecting colored plastics and a second collection chute for collecting transparent plastics.

7. The indexer as claimed in claim 6, wherein the first optical chamber comprises of a camera and a spectrometer for obtaining near infrared spectra of the plastic objects.

8. The indexer as claimed in claim 6, wherein the indexer further comprises of a control panel for comparing the obtained spectra with a database having a spectra of known plastic types.

9. The indexer as claimed in claim 6, wherein the plastic types are selected from a group comprising of polyethylene terephthalate, high density polyethylene, low density polyethylene, polyvinyl Chloride, polypropylene and polystyrene.

10. The indexer as claimed in claim 6, wherein the sorting arrangement includes an air-jet, an ejector chamber and an ejector nozzle arrangement.

11. The indexer as claimed in claim 6, wherein the second optical chamber comprises of a first camera and a second camera for optically scanning the plastic objects to detect colored plastics and transparent plastics.

12. The indexer as claimed in claim 6, wherein the sorting arrangement is configured for sorting the plastic objects based on opacity, transparency, colour and constituent material of the plastic objects.
